(19) United States
(12) Patent Application Publication
(10) Pub. No.: US 2023/0229127 A1
(43) Pub. Date: Jul. 20, 2023

(54) System and Method for Process Control Using Multiple Levels

(71) Applicant: XRI Holdings, LLC, Houston, TX (US)

(72) Inventors: Matt GABRIEL, Houston, TX (US); Chris HARICH, Houston, TX (US)

(21) Appl. No.: 18/097,033

(22) Filed: Jan. 13, 2023

Related U.S. Application Data
(60) Provisional application No. 63/299,333, filed on Jan. 13, 2022.

(51) Int. Cl. G05B 19/042

(52) U.S. Cl. CPC G05B 19/042; G05B 2219/2605

(57) ABSTRACT

A system and method for process control using multiple levels of control is disclosed. The system utilizes a first level of control which provides a dosing regimen based solely on volume. A second level uses predictive analysis or other such tools to predict a dosing regimen. A third level uses an array of small scale testing to test various dosing regimens to determine which one is optimal. If a disruption event occurs for the second or third level, or the system is off-line, the system reverts back to the first level control.

### PRIORITY

The present invention claims priority to U.S. Provisional No. 63/299,333 filed Jan. 13, 2022, the entirety of which is hereby incorporated by reference.

### BACKGROUND OF THE INVENTION

### Technical Field

The present invention relates to a system and method for controlling wastewater treatment.

### Description of Related Art

Drilling, especially fracturing, requires significant volumes of water. Once the water has been used in the drilling operation, the wastewater can be treated and then subsequently re-used. This eliminates or decreases the use of additional fresh water for the drilling operation. The treatment of this wastewater has many different variables. Consequently, there is a need for an improved control system for monitoring and treating of waste water.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a diagram of level one control in one embodiment;

FIG. 2 is a diagram of level two control in one embodiment;

FIG. 3 is a diagram of level three control in one embodiment;

FIG. 4 is a diagram of an optical cell in one embodiment;

FIG. 5 is a diagram of the ignition server in one embodiment.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

As noted, the system and method can be used to control a wastewater treatment process. In one embodiment, discussed in more detail below, there are a plurality of control levels. If a disruption event occurs, then the system automatically reverts to a lower level of control. In one embodiment the system automatically reverts to the base level of control. In the embodiments discussed herein, the base level control is referred to as level one. This is for illustrative purposes only and should not be deemed limiting. In other embodiments, for example, if equipment for level 3 malfunctions, is off-line, or undergoing maintenance, then the system drops from level 3 control to level 2 control as opposed to dropping to level one. Likewise, if a disruption event occurs during level two control, the system will drop to level one control. One of ordinary skill will understand whether dropping to a below level or dropping all the way to a base level will be required.

A disruption event, as used herein, refers to any event which compromises control at the current level of control, or makes the current level of control difficult or impossible. The disruption event can include a probe failure on the equipment or maintenance on the probe. Examples of a disruption event can include, but are not limited to, maintenance, equipment malfunction, etc. As noted, in one embodiment, upon happening of a disruption event, the system automatically reverts to a lower level of dosing. As noted, the lower level can be from a third level of control to a second level of control. In other embodiments, the system will revert to a base level of control.

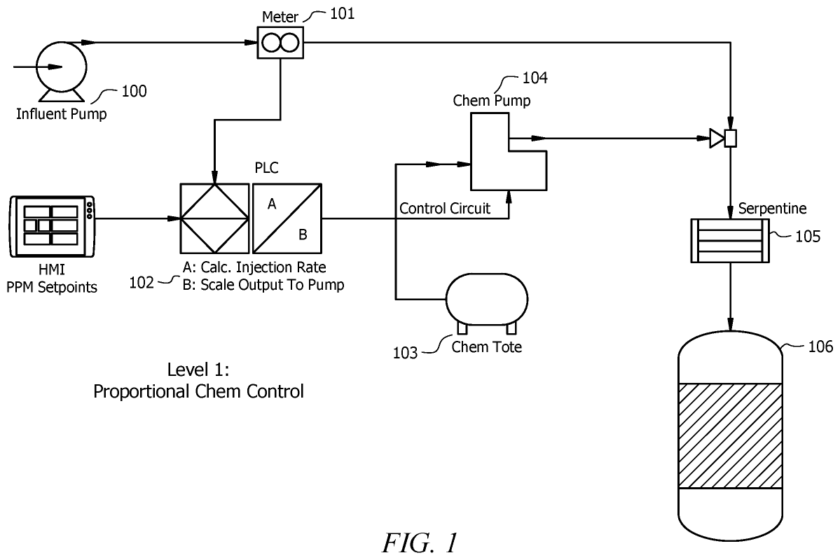

FIG. 1 is a diagram of level one control in one embodiment. In one embodiment, and as depicted, the plurality of levels comprises a first level of dosing control.

In one embodiment, the level one control comprises using volumetric dosing. Put differently, the volume of components added is dependent upon the flow rate of the influent stream. This is also referred to as proportional chemistry control. In this level of control, a proportional amount of a component, or components, is added to treat a volume of influent. Thus, so long as the volume of the influent is known, the required volume of components to treat the influent can utilized to treat the influent.

In some embodiments one or more components are utilized to treat the influent. These components can be housed in a tote and the required volume, based on the volume of the influent, can be added to the influent. Various equipment such as mixing tanks, filters, etc. can be utilized to treat the stream. FIG. 1 shows one such embodiment. FIG. 1 is simplified and supporting equipment such as valves, wiring, etc. is not shown to keep the figure simpler for understanding purposes. While FIG. 1 shows a single chem pump and a single chem tote, this is for illustrative purposes only and should not be deemed limiting. Likewise, while FIG. 1 shows a serpentine 105 and a filter 106, this too is for illustrative purposes only and should not be deemed limiting. Other and separate equipment can be utilized depending upon the influent streams which are being treated.

FIG. 1 shows an influent pump 100. The pump 100 can comprise any pump known in the art. As shown, the pump 100 directs the influent wastewater stream to a meter 101. In other embodiments the meter 101 can be located upstream of the pump 100, within the pump 100, etc. The meter 101 can comprise any meter known in the art which detects and determines flow rate of a liquid stream. The meter 101 is coupled with a controller 102. The controller 102 can comprise virtually any controller known in the art. In one embodiment the controller 102 comprises a PLC. The PLC/controller 102 can be coupled to the meter via any method known in the art including wired and wireless coupling.

A controller 102, such as a PLC, uses set-points and data to determine the appropriate output to the chem pumps 104. A single chem pump 104 is shown, but this is for illustrative purposes only and should not be deemed limiting. As discussed above, the number of chem pumps 104 utilized will depend on the number and volume of components added to the influent stream.

The chem pumps 104, like the influent pump 100, can comprise virtually any pump known in the art. The chem pumps 104 take at least one component stored in the chem tote 103. As noted, while a single chem tote 103 is depicted, this is for illustrative purposes only and should not be deemed limiting. In some embodiments, for example, there are four chem totes 103 each comprising a dissimilar component which is added to treat the influent wastewater stream. Any number of pumps and totes 103 can be utilized depending upon the wastewater stream to be treated.

The chem pumps 104 take components from the chem totes 103 and mixes the components with the influent stream. In the specific embodiment depicted, the resulting mixture is directed to a serpentine 105. The serpentine 105 is any device which increases residence time and promotes mixing. While a serpentine 105 is depicted, this is for illustrative purposes only and should not be deemed limiting. In other embodiments, for example, a mixing tank can be utilized rather than a serpentine. A serpentine 105, in some embodiments, has the advantage of reducing the number of moving parts as well as operational cost.

Once mixed, the mixed stream is directed to the filter 106. In one embodiment, the filter 106 comprises a dissolved air floatation vessel (“DAF”). The DAF filter 106 introduces air bubbles into the tank to help separate lights and heavy solids from the liquids. The air bubbles grab light particles which rise to the surface and can be removed. Simultaneously, heavy particles such as sand will sink to the bottom for subsequent removal. The DAF filter 106 is an example of one efficient filter which can remove particles from the treated stream. The DAF filter 106 is provided as one example, although other filters can also be utilized.

As noted, FIG. 1 shows level one control. As depicted, level one control uses volumetric metering. Thus, a specific volume of each component, such as treatment additives, are added depending upon the volume of the incoming influent stream. Treatment additives, as used herein, are components added to a stream to treat a stream. If there are four components from four chem totes 103, call them Chemistry A, Chemistry B, Chemistry C, and Chemistry D, then the controller/PLC has setpoints for each of the four components. If the volume is 300 gallons per minute, the controller/PLC will instruct the chem pump for Chemistry A that it requires 0.5 gallons per minute, as an example. It may require 0.1 gallons per minute for Chemistry B, 0.2 gallons per minute for Chemistry C, and 0.4 gallons per minute for Chemistry D. The necessary chem pumps 104 will direct the required flow for their respective components. The controller/PLC will direct the specific flow rate until the meter 101 detects a new flow rate. If the flow rate measured by the meter 101 decreases, the controller will calculate the necessary flow rate for each component based on the newly measured flow rate. The controller continues to monitor and adjust the flow rates from the chem pumps 104 based on the flow rate of the influent stream. In one embodiment, the controller determines the flow rate for each chem pump 104 based solely on the flow rate of the influent stream.

As noted, this is referred to as level one control, or the base level control. The system only needs the meter 101 to be operational. Thus, if any of the equipment discussed in the subsequent control levels is inoperable, off-line, or under maintenance, the system switches to level one control. Rather than having to shut down completely, the system switches to level one control. This significantly reduces downtime with the system as it allows any inoperable equipment to be separated from the base level control system. The process continues at level one control until the equipment is operational once again.

Level one control offers a control system to reach a desired output level within the treated wastewater. The desired output level will depend upon the treated wastewater. In some embodiments the treated wastewater will have a target of below a certain parts per million total organic content, as an example. However, the level one control, in some embodiments, may utilize more of the treatment additives than are truly necessary to ensure the treatment requirements are met. Often, these treatment additives are expensive. Thus, while using volumetric control will result in meeting the treatment requirements, it is often not the most cost effective approach. While level one control will meet the specific objective, it does not do so at the most economical approach. High level controls, in some embodiments, also achieve the desired treatment requirements, but take a more nuanced and finely tuned approach to ensure only the amount of treatment additives are utilized. In some embodiment, higher level control, such as level 2 or higher, results in a more economical approach at reaching the desired treatment results. When level 2 or higher control levels are available, they are preferred, in some embodiments. However, upon a disruption event, the system reverts to a lower level of control, such as the base level. While a lower level of control is not as economically desirable, a lower level of control prevents even less desirable shutdown or downtime. While the wastewater stream is not being treated as economically as possible in these lower levels, it is still being treated. In some embodiments, this is preferred to shutting down the system altogether.

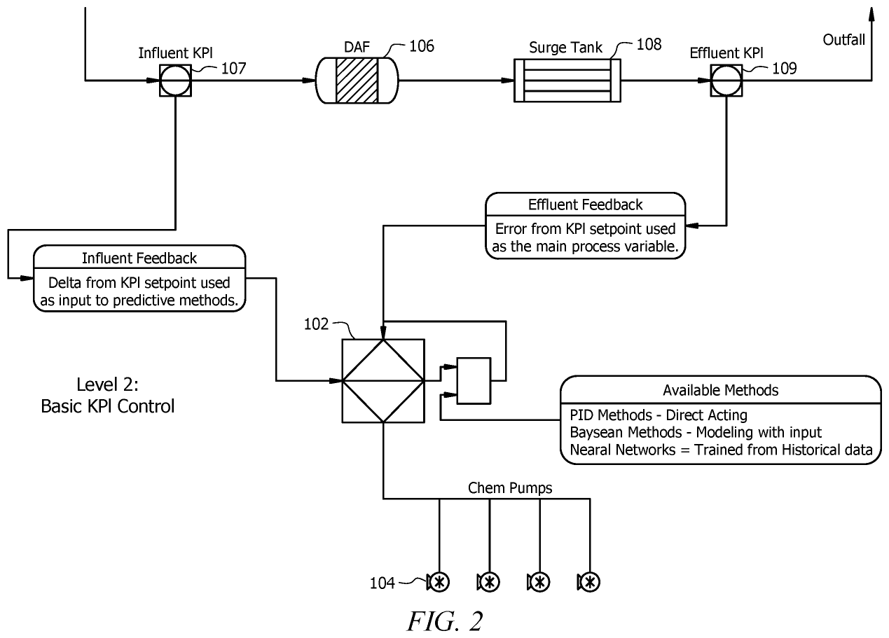

FIG. 2 is a diagram of level two control in one embodiment. Level two control adds various fine tuning and control to level one. Rather than dosing volumetrically only, level two has additional levers to control. In one embodiment, level two has at least one KPI (Key Performance Indicators). As shown there are two KPIs: an influent KPI 107 and an effluent KPI 109. The KPI can measure one or more qualities about the fluid stream. In one embodiment the KPI has a plurality of probes which measure a plurality of stream qualities and conditions. These can range from pH, percent iron, turbidity, total dissolved solids (TDS), and others. These specific qualities are provided for illustrative purposes only and should not be deemed limiting.

The KPI can have various setups depending upon the desired measured qualities. In one embodiment the KPI is a long tube with a plurality of probes fit therein. The various probes measure a specific measured quality. Thus, there will be a probe which measures, pH, as an example. The probes provide an example of components which can malfunction If the pH probe malfunctions, as noted above, the system will revert back to level one control.

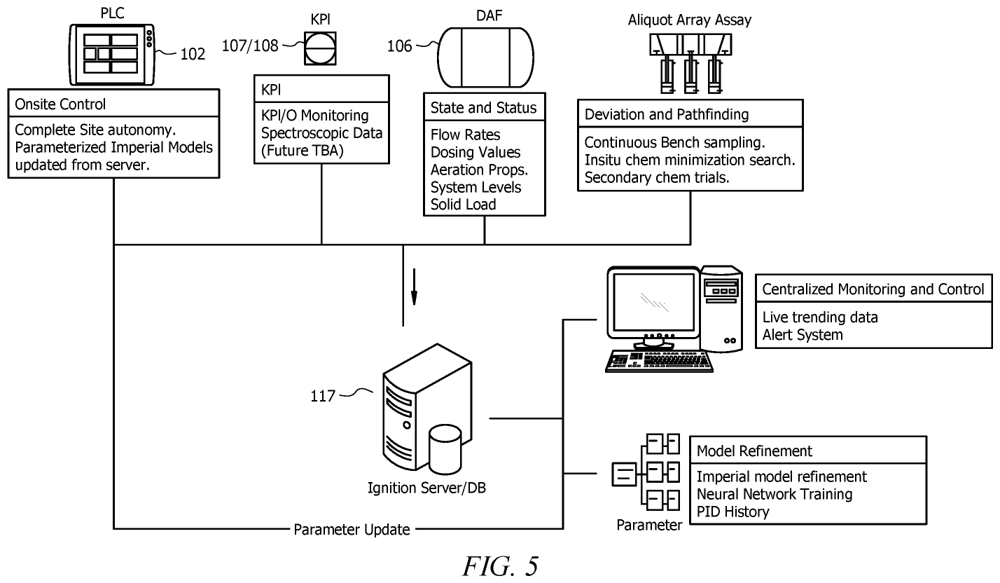

As depicted there are two KPIs. The first KPI is located upstream of the filter 106. The influent KPI 107 can be located upstream or downstream of the meter 101. The influent KPI 107 provides an initial assessment of the quality of the stream. Sticking with the pH example, the influent KPI 107 will provide the measured pH of the stream upstream of the filter 106. The PLC 102 can then send the data from the KPI 107 to the controller 117 (FIG. 5) which controls the system. As noted, the controller 117 can be located onsite, remotely, or on the cloud.

During level two control, the controller 117 uses one or more data sets from the KPI 107 to determine which components, and how much, from the chem totes 103 should be added. If, as an example, the pH is too low, the controller 117 will determine that a basic component from the chem tote 103 should be added to raise the pH.

As can be seen, if four qualities are measured, there are four variables to be balanced, optimized, etc. by adjusting the type and volume of additives/components from the chem totes 103. Thus, in one embodiment, the second level comprises utilizing one or more data sets of at least one KPI to determine volumes of an additive to optimize one or more variables.

In one embodiment, additional data is obtained and analyzed from the effluent KPI 109. As depicted, the effluent KPI 109 is located downstream of the filter 106. As shown in FIG. 2, the effluent KPI 109 is located downstream of a surge tank 108.

The effluent KPI 109 provides an additional data set and an opportunity to measure the same or different qualities as measured in the influent KPI 107. In one embodiment, the same qualities are measured in the influent KPI 107 and the effluent KPI 109. This allows the system to get feedback on the specific components and amounts of components added to the stream. Thus, if a specific amount of base was added to raise the pH, the effluent KPI 109 allows the system to determine if sufficient base was added to reach the desired pH or if addition or less components would be needed in the future. The effluent KPI 109 provides an opportunity for the system to “grade” the specific dosing regimen implanted and determine its success. If it is determined that not enough of a component was added from the effluent KPI 109, then the controller 117 can make necessary adjustments to add more of the relevant components from the chem totes 103.

The same analysis and process can be implemented across all of the plurality of qualities measured from the KPIs. In one embodiment a direct method is utilized. A quality such as pH is measured, and a dosage of a component is calculated based on that pH.

In other embodiments level two control comprises a Bayesian method. The Bayesian method softens the direct method. The Bayesian method builds models and predictive analysis based on a variety of factors to predict which components, dosage volumes, and dosing time, to predict a more accurate dosing approach. The Bayesian method can utilize data from the KPIs to change the dosing conditions based on the stream qualities and treated qualities. Those of ordinary skill will understand how to implement the Bayesian methods.

In another embodiment level two utilizes machine learning through neuronet historical data. As shown above, there is considerable data which can be obtained. The system can record and maintain this data. The data will have information related to qualities of the stream, which components were added, how much was added, and the final result. The historical data allows the system to see which dosing changes were successful based on a specific stream. Later, when a similar stream is encountered, rather than relying upon direct dosing, or Bayesian methods, the historical data can be examined and the same or similar previous approach can be implemented. Thus, rather than predict a dosing regimen which the system predicts will work, the system can use a dosing regimen which has proven successful in the past. Even if the stream doesn't possess the exact qualities, if the qualities are somewhat similar, the machine learning can propose a dosing regimen which will be very close to what is necessary. Then, based on the success determined by the effluent KPI 109, adjustments can be made in real time as necessary.

The historical data provides an opportunity for the system to quickly determine at least a starting point for the dosing system. As noted previously, if the historical data is off-line, the system will then revert to other dosing calculations. As an example, the system will then revert to Bayesian methods to calculate and formulate a dosing regimen. If the equipment necessary for the Bayesian method is not available, the system will then revert to a lower level control system, such as level one. Those of ordinary skill will be able to prioritize and provide a hierarchy which is relevant to the control system.

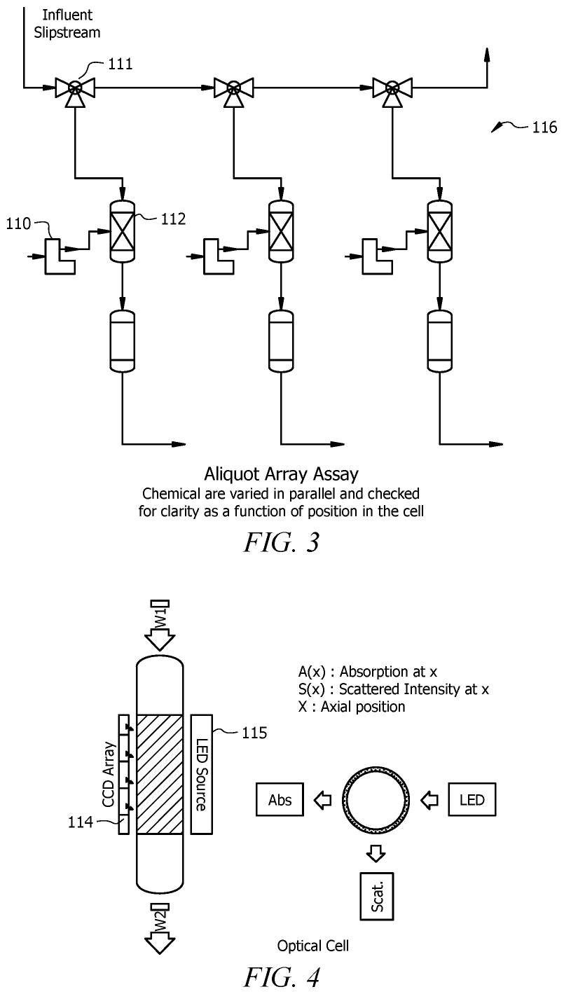

FIG. 3 is a diagram of level three control in one embodiment. As depicted, FIG. 3 shows an aliquot array assay. As shown is a series of pumps 110 and valves 112 for each array. The array assembly allows small trials to be attempted. The array assembly takes a small volume of an untreated stream, adds various dosages to the stream, and then measures the resulting product. The arrays allow testing of various chemistry applications in small batches on the current influent water.

In one embodiment, and as depicted in FIG. 4, the results are measured with an optical cell. FIG. 4 is a diagram of an optical cell in one embodiment. The array assembly provides the opportunity to attempt a variety of combinations of components to determine, in real time in some embodiments, the most optimal combination for that specific stream. The optical cell, in one embodiment, allows the passage of light through each batch which has different chemistry. The light will refract, absorb, and fluoresce differently. These readings will provide results and indicate which dosage of chemistry should be used on the current water being treated. Various properties can be measured and monitored with the optical cell to determine the optimal treatment for that specific water. Because actual and different chemistry applications are applied, the optimal chemistry can be utilized for that specific water rather than using volumetric or historic data. In some embodiments, this results in a more optimized approach to the additives. This results in cost savings as well as optimized treating.

The array assembly can take place in-line or off-line. The array assembly automates the batch attempts previously completed by hand. As an example, if a new stream with a new chemistry is introduced, the user could physically titrate and try various dosing regimens to see which one is optimal. Unfortunately, this takes a lot of time and results in downtime to the system. The array assembly, in one embodiment, is automated and provides very fast results. This is an opportunity for the system to make real-world attempts at optimizing a dosing regimen for a specific stream. If an optimized regimen is found, the system can implement that regimen.

The array assembly has several advantages. The array assembly provides the ability to try one or more small scale trials using real world chemistry to determine what works and does not work. Rather than relying on direct or predictive dosing regimens, the array assembly provides actual trials with actual results. The array assembly is particularly helpful when a new stream with new chemistry is presented. In some embodiments, the new stream will be so unrelated to previous streams that predictive analysis, or historical data, are insufficient to predict a dosing regimen. In those situations, the array assembly can determine an initial dosing regimen.

In one embodiment the array allows chemicals to be varied in parallel and checked for clarity as a function of position within the cell. Thus, several different applications can be applied to determine which dosage offers the best results. The dosing regime identified by the array can then be scaled and utilized in the larger dosing system.

As noted previously, in the event the array assembly is off-line due to malfunction of equipment, maintenance, etc., then the system can revert to a lower level control. As an example, the system can revert to level two whereby the system can utilize predictive analysis or use historical data to formulate a dosing regimen. If level two is likewise unavailable, the system will utilize level one controls.

As noted, this has significant benefits. Equipment goes down, and equipment must be routinely maintained, balanced, and calibrated. These are all examples of disruption events. In previous control systems, if one piece of equipment was down, the entire system was down. The incoming stream would be stopped, and the entire system would come to a halt. This is undesirable for a host of reasons. First, stopping and starting equipment is often problematic. Second, stopping the treatment system does not stop the incoming wastewater stream which must be held and stored until the system is online. Third, producing clean treated water is how the system is monetized. Simply, stopping the system is undesirable Eliminating or decreasing the amount of time the system is down is beneficial. The system discussed herein allows the system to continue even in the event that higher level control systems are down for whatever reason. The system can always revert back to level one control and control based on volumetric dosing. Then, when high level control system equipment is back on-line, the system can then switch to a higher, and often more efficient, control level.

As noted, in some embodiments, it is more economically desirable to operate at higher control levels. Thus, operating at control level two is often more economically desirable than control level one. If a disruption event occurs and the system reverts to level one, in some embodiments, it is less expensive to operate at level two. However, as noted, it is still preferred that the system stay on-line. Accordingly, in such embodiments, the system will operate at level one control until a higher control level becomes available. At that point, the controller will shift to level two, level three, etc.

FIG. 5 is a diagram of the ignition server in one embodiment. In one embodiment FIG. 5 depicts a diagram of the internet of things (IOT) system. As shown, the ignition server 117 utilizes data from a variety of sources to formulate a dosing regimen. As noted, the ignition server 117 acts as the global controller and can be located locally, remotely, in the cloud, etc. As shown, the ignition server 17 is coupled to, and receives data from, the controller/PLC 102, the KPIs 107/108, the filter 106, and the aliquot array assay 116. The ignition server 117 can utilize hierarchy control, assigned weights, etc. to determine how to prioritize the data and ultimately control the system to reach the desired targets.

While the invention has been particularly shown and described with reference to a preferred embodiment, it will be understood by those skilled in the art that various changes in form and detail may be made therein without departing from the spirit and scope of the invention.

What is claimed is:

1. A system for dosing, said system comprising:
a plurality of levels of dosing control;
wherein said plurality of levels comprises a first level of dosing control;
wherein said first level comprises volumetric dosing;
wherein said plurality of levels comprises a second level of dosing control;
wherein said second level comprises at least one key performance indicator (KPI) to optimize control;
wherein upon a disruption event, said system reverts to a lower level of dosing control.

2. The system of claim 1 wherein said system is used on a wastewater treatment process.

3. The system of claim 1 wherein said first level comprises proportional chemistry control.

4. The system of claim 1 wherein said first level further comprises:
at least one influent pump;
a meter coupled to said influent pump;
wherein said meter is coupled to a controller;
a first chem pump coupled to a first chem tote.

5. The system of claim 4 wherein said controller directs said first chem pump based on said meter.

6. The system of claim 4 further comprising:
a serpentine located downstream of said chem pump;
a filter located downstream of said serpentine.

7. The system of claim 1 wherein said at least one KPI comprises an influent KPI.

8. The system of claim 7 wherein said at least one KPI further comprises at least one effluent KPI.

9. The system of claim 1 wherein said second level comprises utilizing one or more data sets of at least one KPI to determine volumes of an additive to adjust said at least one KPI.

10. The system of claim 1 wherein said second level comprises utilizing a Bayesian method of control.

11. The system of claim 1 wherein said second level comprises utilizing historical data to aid in control.

12. The system of claim 1 wherein said second level comprises utilizing machine learning through neuronet historical data.

13. The system of claim 1 wherein said plurality of levels comprises a third level of dosing control, wherein said third level of control comprises an aliquot array assay.

14. The system of claim 13 wherein said array assembly takes place in-line.

15. The system of claim 13 wherein upon a disruption event with said aliquot array assay, said system reverts to said level two dosing.

16. The system of claim 4 wherein said system comprises at least four chem pumps, each coupled to one chem tote.

17. The system of claim 1 utilized to treat wastewater in a fracturing system.
